(19) United States
(12) Patent Application Publication
(10) Pub. No.: US 2009/0314943 A1
(43) Pub. Date: Dec. 24, 2009

(54) SYSTEM AND METHOD FOR TERAHERTZ IMAGING

(75) Inventors: Michael Breit, Munchen (DE); Thorbjorn Christopher Buck, Munchen (DE)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 12/145,263

(22) Filed: Jun. 24, 2008

(51) Int. Cl. G01J 5/10

(52) U.S. Cl. 250/341.1; 324/642

(57) ABSTRACT

A security inspection system is provided. The security inspection system includes a source configured to transmit a beam of radiation comprising a frequency of at least about 10 GHz. The system also includes an optical system configured to focus the beam of radiation on a sample. The system further includes at least one detector configured to detect one or more reflected beams from different locations of the sample in a focal plane of the optical system and generate a corresponding output signal. The system also includes a processor coupled to the at least one detector and configured to reconstruct a three dimensional image of the sample based upon the output signal.

### BACKGROUND

The invention relates generally to inspection systems and, more particularly, to inspection systems employing terahertz imaging.

A wide variety of inspection systems have been developed that may be utilized in security applications, such as, but not limited to, security screening of passenger luggage, packages, and/or cargo. For example, inspection systems are employed at various public or private installations, such as airports, for screening persons, luggage, packages and cargo, to detect the presence of contraband (e.g., weapons, explosives and drugs). Such systems include metal detectors, X-ray based inspection systems, nuclear magnetic resonance based inspection systems, nuclear quadruple resonance based inspection systems, and so forth. In such applications, acquired data and/or generated images may be used to detect objects, shapes or irregularities which are otherwise hidden from visual inspection and which are of interest to the screener. However, these imaging and/or inspection systems have one or more of various limitations such as low reliability in detecting explosives and drugs (leading to high rates of false alarms), health risk to screeners and those being screened due to exposure to harmful radiation, long screening time (leading to decreased throughput at checkpoints), and so forth.

Although many computed tomography (CT) based systems exhibit an excellent probability of detection, these systems are susceptible to high false alarm rates. A common reason for the generation of a false alarm is that conventional CT sensors have difficulty in distinguishing actual threat objects from harmless objects since these objects may exhibit similar threat definitions (for example, similar density and mass). Although there has been continued effort to improve false alarm rates of explosives detection systems employing CT technologies, for example, improvement is still needed.

Furthermore, the aforementioned X-ray transmission systems are not able to effectively detect materials (such as plastics or plastic explosives), especially when shaped into objects of thin cross-section, since they cause relatively small attenuation of X-rays. On the other hand, some X-ray scatter systems are not able to consistently identify threat material such as weapons, explosives or drugs located deep inside an object.

Accordingly, there is a need for an inspection system that can reliably detect threat material being located anywhere in an examined object.

### BRIEF DESCRIPTION

In accordance with an embodiment of the invention, an inspection system is provided. The inspection system includes a source configured to transmit a beam of radiation comprising a frequency of at least about 10 GHz. The inspection system also includes an optical system configured to focus the beam of radiation on a sample. The inspection system further includes at least one detector configured to detect one or more reflected beams from different locations of the sample in a focal plane of the optical system and generate a corresponding output signal. The inspection system also includes a processor coupled to the at least one detector and configured to reconstruct a three dimensional image of the sample based upon the output signal.

In accordance with another embodiment of the invention, a method for manufacturing an inspection system is provided. The method includes providing a source configured to transmit a beam of radiation comprising a frequency of at least about 10 GHz. The method also includes providing an optical system configured to focus the beam of radiation on a sample. The method further includes providing at least one detector configured to detect one or more reflected beams from different locations of the sample in a focal plane of the optical system and generate a corresponding output signal. The method also includes providing a processor coupled to the at least one detector and configured to reconstruct a three dimensional image of the sample based upon the output signal.

These and other advantages and features will be more readily understood from the following detailed description of preferred embodiments of the invention that is provided in connection with the accompanying drawings.

### DRAWINGS

FIG. 1 is a schematic representation of an inspection system including terahertz radiation in accordance with an embodiment of the invention.

FIG. 2 is a diagrammatic illustration of an exemplary application of the inspection system in FIG. 1.

FIG. 3 is a flow chart representing steps in a method for manufacturing an inspection system in accordance with an embodiment of the invention.

### DETAILED DESCRIPTION

As discussed in detail below, embodiments of the invention include a system and method for terahertz imaging. Generally, the system and method may be used in a variety of terahertz imaging and/or spectroscopy systems, such as for medical imaging, industrial quality control, and security screening. Though the present discussion provides examples in a context of security screening, one of ordinary skill in the art will readily comprehend that the application in other contexts, such as for medical imaging and industrial quality control, is well within the scope of embodiments of the invention.

It should be noted that reference is made herein to a “sample” that is to be imaged or scanned. The use of the term “sample” is not intended to limit the scope of the appended claims and may broadly indicate a human, an animal, a sealed package, luggage such as a briefcase or a suitcase, a carton, or a cargo container that may be employed to carry an object of interest such as explosives, drugs, weapons, or other contraband. In general, the term may include any article, system, vehicle, or support in which or on which contraband may be placed. Moreover, the subject may refer to objects being examined for a defect via nondestructive evaluation, carrier tissue in a tooth during dental imaging, cancerous tissue in a body during medical imaging, and so forth.

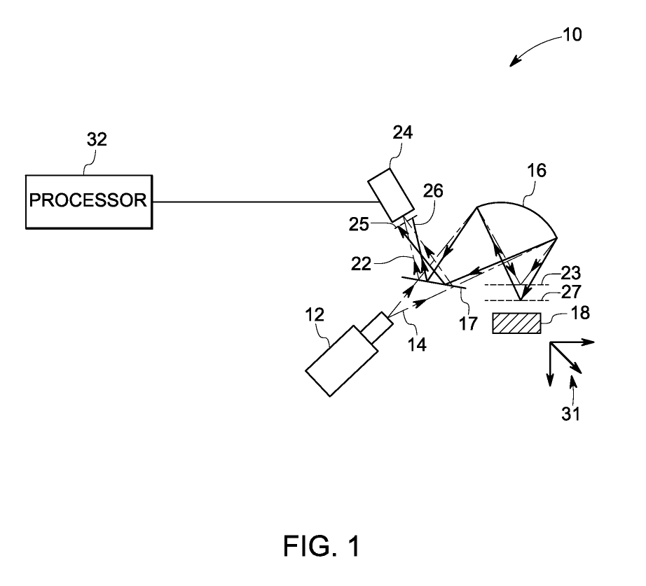

FIG. 1 is a diagrammatic illustration of an inspection system 10 employing a radiation source 12 having a frequency of at least about 10 GHz. In an exemplary embodiment, the source 12 includes at least one of a continuous wave laser source, a backward wave oscillator source, a quantum cascading laser source, a multiplier chain source, a gas laser source, or other high-power source. Radiation beams 14 emitted from the source 12 are captured by an optical system 16. The optical system 16 focuses the radiation beams 14 on to a sample 18 to be examined. In one embodiment, the optical system 16 includes at least one mirror configured to focus the beams 14 onto the sample 18. Non-limiting examples of the sample include luggage, shoes, clothing, or a cardboard box. The radiation beams 14 are reflected from the sample 18 resulting in reflected beams 22. The reflected beams 22 that are in a focal plane, referenced by numeral 23, of the optical system 16 are further incident upon a detector 24, while the reflected beams 26 that are not in a focal plane, referenced by 27, are not allowed to be incident upon the detector 24. It will be appreciated that an array of detectors 24 may also be employed.

In a particular embodiment, the optical system 16 includes a pinhole camera 25 that transmits the reflected beams 22 that are in focus onto the detector and prevents the reflected beams 26 that are out of focus from reaching the detectors 24. In another embodiment, the optical system 16 includes a beamsplitter 17 that splits the reflected beams 22, 24. A whole volume of the sample 18 may be scanned along a third dimension either by actuating the sample relative to the optical system 16 or by actuating the optical system relative to the sample 18. The actuation ensures different locations within the sample are brought in focus resulting in the detection of an entire volume of the sample 18. The sample 18 and the optical system 16 may be actuated in at least one of three dimensions referenced by numeral 31. The detector 24 detects the beams 22 to generate a corresponding output signal 32. A processor 34 is coupled to the detector 24 to generate multiple two dimensional images of different locations within the sample 18 based upon the output signal 32 and further reconstruct the two dimensional images to generate a three dimensional image. It should be noted that any suitable reconstruction algorithm known in the art, may be employed to generate an image from the detector output signal 32.

It should be noted that embodiments of the invention are not limited to any particular processor for performing the processing tasks of the invention. The term “processor,” as that term is used herein, is intended to denote any machine capable of performing the calculations, or computations, necessary to perform the tasks of the invention. The term “processor” also is intended to denote any machine that is capable of accepting a structured input and of processing the input in accordance with prescribed rules to produce an output. It should also be noted that the phrase “configured to” as used herein means that the processor is equipped with a combination of hardware and software for performing the tasks of embodiments of the invention, as will be understood by those skilled in the art.

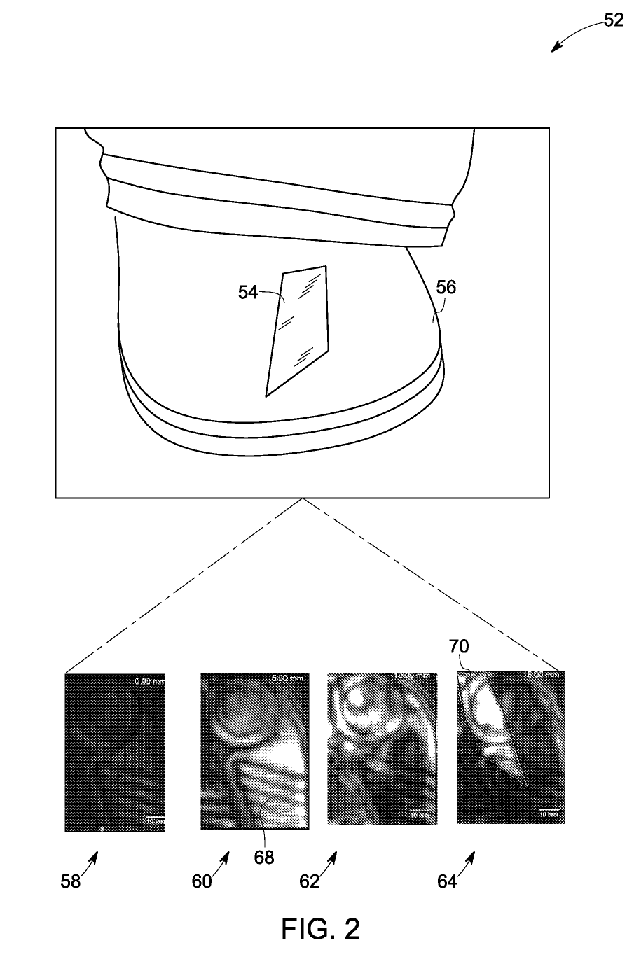

FIG. 2 is a schematic illustration of an exemplary application of the inspection system 10. The inspection system 10 examines a shoe 52 that includes a ceramic knife 54 embedded within a sole 56 of the shoe 52. The shoe 52 is scanned at different depths to locate the knife 54. As described above, depths that lie in a focal plane of the optical system 16 (FIG. 1) are incident on the detector 24 (FIG. 1) generating multiple two dimensional images and further reconstructed to produce a three dimensional image. As illustrated herein, images 58, 60, 62 and 64 represent locations within the shoe 52 at a depth of 0 mm, 5 mm, 10 mm, and 15 mm respectively. The depth is measured from a top of the shoe 52. Image 58 corresponds to a surface of the shoe 52 and is relatively blurred, while as the shoe 52 is further scanned such that locations within the shoe 52 at a depth of 5 mm are in focus, a clearer image 60 of the shoe 52 is produced showing ripples 68 on the sole 56. Similarly, the ripples 68 get blurred in the image 62 at a depth of 10 mm and furthermore, the image 64 at a depth of 15 mm starts to focus on a location 70 of the knife 54.

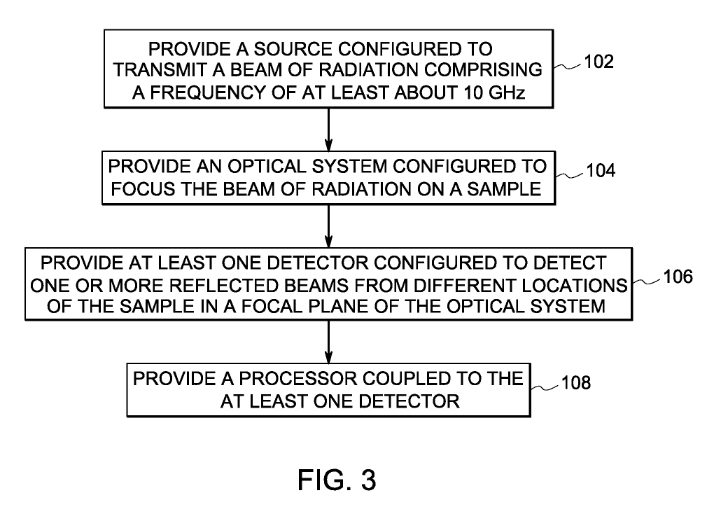

FIG. 3 is a flow chart representing steps in a method for manufacturing an inspection system. The method includes providing a source configured to transmit a beam of radiation comprising a frequency of at least about 10 GHz in step 102. In one embodiment, a continuous wave laser source, a backward wave oscillator source, a quantum cascading laser source, a multiplier chain source, a gas laser source, or other high-power source is provided. An optical system is provided in step 104 to focus the beam of radiation on a sample to be examined. In a particular embodiment, at least one mirror is provided that focuses the beam of radiation onto the sample. In another embodiment, a beamsplitter is provided that splits one or more reflected beams from the sample. At least one detector is provided in step 106 to detect one or more reflected beams from different locations of the sample in a focal plane of the optical system and generate a corresponding output signal. A processor is provided in step 106 and is coupled to the at least one detector to generate a three dimensional image of the sample based upon the output signal. In one embodiment, the processor reconstructs multiple two dimensional images obtained from the at least one detector, to generate the three dimensional image. In an exemplary embodiment, the sample is actuated in at least one of three dimensions relative to the optical system to scan an entire volume of the sample. In another embodiment, the optical system is actuated relative to the sample to scan an entire volume of the sample.

The various embodiments of a system and method for inspection of threat material in objects as described above thus provide a convenient, cost effective and efficient means to prevent security incidents from occurring. Three dimensional tomographic imaging with harmless terahertz radiation provide increased detection capability for objects such as, but not limited to, metal, ceramic, weapons, special nuclear materials, and explosives. The technique enables determining a three dimensional size of a defect by increasing resolution in the third dimension. Advantageously, terahertz radiation is also non-ionizing and not hazardous as compared to X-ray radiation. The system and technique described above also facilitate reduction of false alarms, consequently reducing expensive and time consuming secondary inspections of objects.

It is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

Furthermore, the skilled artisan will recognize the interchangeability of various features from different embodiments. For example, the use of a backward wave oscillation source described with respect to one embodiment can be adapted for use in inspection of shoes described with respect to another. Similarly, the scanning in a third dimension may be achieved either by scanning the object along the third dimension or by scanning the optical system along the third dimension. Further, the various features described, as well as other known equivalents for each feature, can be mixed and matched by one of ordinary skill in this art to construct additional systems and techniques in accordance with principles of this disclosure.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed as new and desired to be protected by Letters Patent of the United States is:

1. An inspection system comprising:
a source configured to transmit a beam of radiation comprising a frequency of at least about 10 GHz;
an optical system configured to focus the beam of radiation on a sample, the optical system comprising a pinhole camera configured to transmit one or more reflected beams;
at least one detector configured to detect one or more reflected beams from different locations of the sample in a focal plane of the optical system and generate a corresponding output signal; and
a processor coupled to the at least one detector and configured to reconstruct a three dimensional image of the sample based upon the output signal.

2. (canceled)

3. The system of claim 1, wherein the optical system comprises at least one mirror configured to focus the beam of radiation on to the sample.

4. The system of claim 1, wherein the optical system comprises a beamsplitter configured to split the beam of radiation transmitted from the source and the one or more reflected beams from the sample.

5. The system of claim 1, wherein the sample comprises luggage, shoes, clothing, or a cardboard box.

6. The system of claim 1, wherein the source comprises a continuous wave laser source, a backward wave oscillator source, a quantum cascading laser source, a multiplier chain source, a gas laser source, or other high-power source.

7. The system of claim 1, wherein the sample is configured to be actuated in at least one of three dimensions relative to the optical system to scan an entire volume of the sample.

8. The system of claim 1, wherein the optical system is configured to be actuated in at least one of the three dimensions relative to the sample to scan an entire volume of the sample.

9. The system of claim 1, wherein the processor is configured to generate a plurality of two-dimensional images based upon the output signal.

10. A method for manufacturing an inspection system comprising:
providing a source configured to transmit a beam of radiation comprising a frequency of at least about 10 GHz;
providing an optical system configured to focus the beam of radiation on a sample, the optical system comprising a pinhole camera configured to transmit one or more reflected beams;
providing at least one detector configured to detect one or more reflected beams from different locations of the sample in a focal plane of the optical system and generate a corresponding output signal; and
providing a processor coupled to the at least one detector and configured to generate a three dimensional image of the sample based upon the output signal.

11. The method of claim 10, wherein said providing a source comprises providing a continuous wave laser source, a backward wave oscillator source, a quantum cascading laser source, a multiplier chain source, a gas laser source, or other high-power source.

12. (canceled)

13. The method of claim 10, wherein said providing an optical system comprises providing at least one mirror configured to focus the beam of radiation onto the sample.

14. The method of claim 10, wherein said providing an optical system comprises providing a beamsplitter configured to split the one or more reflected beams from the sample.

15. The method of claim 10, comprising actuating the sample in at least one of three dimensions relative to the optical system to scan an entire volume of the sample.

16. The method of claim 10, further comprising actuating the optical system relative to the sample to scan an entire volume of the sample.

17. The method of claim 10, wherein said providing a processor comprises reconstructing a plurality of two dimensional images obtained from the at least one detector to generate the three dimensional image.
